(19) United States
(12) Patent Application Publication
(10) Pub. No.: US 2005/0257008 A1
(43) Pub. Date: Nov. 17, 2005

(54) Program conversion apparatus and processor

(75) Inventors: Koji Nakajima, Kyoto (JP); Kensuke Odani, Kyoto (JP)

Correspondence Address: MCDERMOTT WILL & EMERY LLP, 600 13TH STREET, N.W., WASHINGTON, DC, 20005-3096, US

(73) Assignee: MATSUSHITA ELECTRIC INDUSTRIAL CO., LTD.

(21) Appl. No.: 11/106,452

(22) Filed: Apr. 15, 2005

(30) Foreign Application Priority Data
May 11, 2004 (JP) 2004-140700

(51) Int. Cl. G06F 12/00

(52) U.S. Cl. 711/118

(57) ABSTRACT

A program conversion apparatus converts an input program into a program operable by a processor using a cache memory and outputs the converted program. The program conversion apparatus includes a target region extraction section for extracting from regions of a memory, as a target region, a region in which writing is performed before reading during execution of the input program, and a cache entry specification section for inserting a cache entry specification instruction to add an entry to the cache memory before an instruction to execute a write access to the target region.

### CROSS-REFERENCE TO RELATED APPLICATION

The disclosure of Japanese Patent Application No. 2004-140700 filed on May 11, 2004 including specification, drawings and claims are incorporated herein by reference in its entirety.

### BACKGROUND OF THE INVENTION

The present invention relates to a program conversion apparatus for a processor using a cache memory for increasing the speed of memory access.

In recent processors, a small-capacity and high-speed cache memory such as an SRAM (static random-access memory) is disposed in or in the vicinity of a processor and part of data is stored in the cache memory, so that the speed of memory access of the processor is increased.

If data is not present in a cache memory during a read access or a write access, a cache miss occurs. Data is newly read from a main memory to an empty block in the cache memory and part of an address is stored as an entry in the cache memory. In this case, if no empty block is present, data stored in one of a plurality of blocks constituting the cache memory needs to be written back to the main memory.

On the other hand, there might be cases where reading to a cache memory is unnecessary or where write-back to a main memory is unnecessary. For example, if the processor does not refer to data read to a cache memory and performs writing to the whole region of the data, reading to the cache memory is not necessary. Moreover, if data in the cache memory is temporary data and is not to be used afterward, write-back of the data to the main memory is unnecessary.

As methods for eliminating the unnecessary reading to a cache memory or the unnecessary write-back to a main memory descried above, the followings have been known. For example, in Japanese Laid-Open Publication No. 8-137748, disclosed is the point that in a program conversion apparatus, a variable that is not to be referred to afterward is obtained and a flag indicating that a cache block is write-only is set, so that unnecessary write-back to a main memory is eliminated.

Moreover, for example, in Japanese Laid-Open Publication No. 2003-223360, the following point is disclosed. When a region which has been once allocated is released, a dirty flag indicating that contents of a cache memory are newer than those of a main memory is reset for a region known as a region not to be referred to, thereby eliminating unnecessary write-back to the main memory and unnecessary reading from the main memory.

However, according to the above-described known techniques, an instruction to eliminate unnecessary reading from a main memory to a cache memory is given only for a region in which reading to a cache memory has been performed at least once. Accordingly, when writing is performed to a region in which reading from a main memory to a cache memory has never performed, an instruction to eliminate unnecessary reading from the main memory to the cache memory can not be given.

### SUMMARY OF THE INVENTION

It is therefore an object of the present invention to provide a program conversion apparatus for performing conversion to a program for performing writing to a region in which reading from a main memory to a cache memory has never been performed, so that unnecessary reading from the main memory to the cache memory is eliminated.

Also, it is an object of the present invention to provide a processor suitable for executing a program converted by the program conversion apparatus.

Specifically, the present invention is directed to a program conversion apparatus for converting an input program into a program operable by a processor using a cache memory and outputting the converted program. The apparatus includes: a target region extraction section for extracting from regions of a memory, as a target region, a region in which writing is performed before reading during execution of the input program; and a cache entry specification section for inserting a cache entry specification instruction to add an entry to the cache memory before an instruction to execute a write access to the target region.

Thus, when the input program is executed, even though writing is performed to a region in which reading from a main memory to the cache memory has never been performed, an instruction to add an entry to the cache memory for the region is inserted. Accordingly, a program which eliminates unnecessary reading from the main memory to the cache memory can be output.

Moreover, in the program conversion apparatus, it is preferable that the target region extraction section includes a variable extraction section for extracting a variable for which a continuous region is allocated and to which writing is started before reading from the variable, and assuming a region corresponding to the variable to be the target region.

Moreover, in the program conversion apparatus, it is preferable that the target region extraction section includes a write determined region extraction section for extracting, as the target region, a region in which it is determined that writing is performed before reading according to the nature of program language of the input program.

Moreover, it is preferable that the write determined region extraction section includes a stack region extraction section for extracting, as the target region, a stack region to be allocated when a function is called.

Moreover, it is preferable that the write determined region extraction section includes a heap region extraction section for extracting, as the target region, a heap region to be dynamically allocated during execution of the input program.

Moreover, it is preferable that the write determined region extraction section includes an initialized region extraction section for extracting, as the target region, a region of a variable determined to be initialized when execution of the input program is started.

Moreover, it is preferable that the target region extraction section includes a programmer specified region extraction section for extracting a specified region as the target region.

Moreover, it is preferable that the cache entry specification section includes a start address analysis section for analyzing an alignment of a start address of the target region.

Moreover, it is preferable that the cache entry specification section includes an adjacent region analysis section for analyzing whether or not an adjacent region to be stored in the same cache line as the target region is referred to in the input program and adding, if the adjacent region is not referred to, the adjacent region to the target region.

Moreover, it is preferable that the cache entry specification section includes a size judgment section for controlling, if no cache line to be entirely included in the target region is present, the cache entry specification section so that the cache entry specification section does not output the cache entry specification instruction.

Moreover, it is preferable that the size judgment section performs, if a start address of the target region is not determined, control so that the cache entry specification instruction is output when the target region has a size with which the target region unfailingly includes a whole single cache line.

Moreover, it is preferable that the size judgment section performs, if a start address of the target region is not determined, control so that the cache entry specification instruction is output when the target region has a size with which there is the possibility that the target region includes a whole single cache line.

Furthermore, according to another aspect of the present invention, a processor includes: a processing section for executing, by a single instruction, an operation by an instruction to update an address of a pointer indicating a stack region and an operation by an instruction to add an entry to a cache memory.

With the program conversion apparatus of the present invention, even if writing is performed to a region in which reading from a main memory to a cache memory has never been performed, a program which eliminates unnecessary reading from the main memory to the cache memory can be output. Therefore, the speed of execution of the program can be increased and also power consumption during the execution can be reduced.

### BRIEF DESCRIPTION OF THE DRAWINGS

FIG. 1 is a block diagram illustrating an exemplary configuration of a cache memory device according to the present invention.

FIG. 2A is an explanatory drawing illustrating an exemplary cache entry specification instruction; and FIG. 2B is an explanatory drawing illustrating setting of a read unnecessary line in response to a cache entry specification instruction.

FIG. 3 is a block diagram illustrating an exemplary configuration of a program conversion apparatus according to an embodiment of the present invention.

FIG. 4 is a table illustrating an example of management information of FIG. 3.

FIG. 5 is an explanatory drawing describing the operation of an output program generated by the program conversion apparatus of FIG. 3.

FIG. 6 is an explanatory drawing illustrating the operation of a variable extraction section of FIG. 3.

FIG. 7 is a block diagram illustrating an exemplary configuration of a write determined region extraction section of FIG. 3.

FIG. 8A is an explanatory drawing illustrating an example of allocation of a stack region when a function is called; and FIG. 8B is an explanatory drawing describing the operation of a stack region extraction section of FIG. 7.

FIG. 9 is an explanatory drawing illustrating an exemplary instruction to support the operation of the stack region extraction section of FIG. 7.

FIG. 10A is an explanatory drawing describing the operation of a heap region extraction section of FIG. 7; and FIG. 10B is an explanatory drawing illustrating an exemplary memory region to be dynamically allocated.

FIG. 11A is an explanatory drawing describing the operation of an initialized region extraction section of FIG. 7; and FIG. 11B is an explanatory drawing illustrating an exemplary memory region to be allocated as an external variable region.

FIG. 12 is an explanatory drawing describing the operation of a programmer specified region extraction section of FIG. 3.

FIG. 13 is an explanatory drawing describing the operation of a start address analysis section of FIG. 3.

FIG. 14 is an explanatory drawing describing the operation of an adjacent region analysis section of FIG. 3.

FIG. 15A is an explanatory drawing illustrating an exemplary target region having a necessary size for making the target region unfailingly include a read unnecessary line; and FIG. 15B is an explanatory drawing illustrating an exemplary target region including a read unnecessary line and having a minimum size.

FIG. 16 is an explanatory drawing describing the operation of the entry specification instruction output section of FIG. 3.

### DESCRIPTION OF THE PREFERRED EMBODIMENTS

Hereafter, embodiments of the present invention will be described with reference to the accompanying drawings.

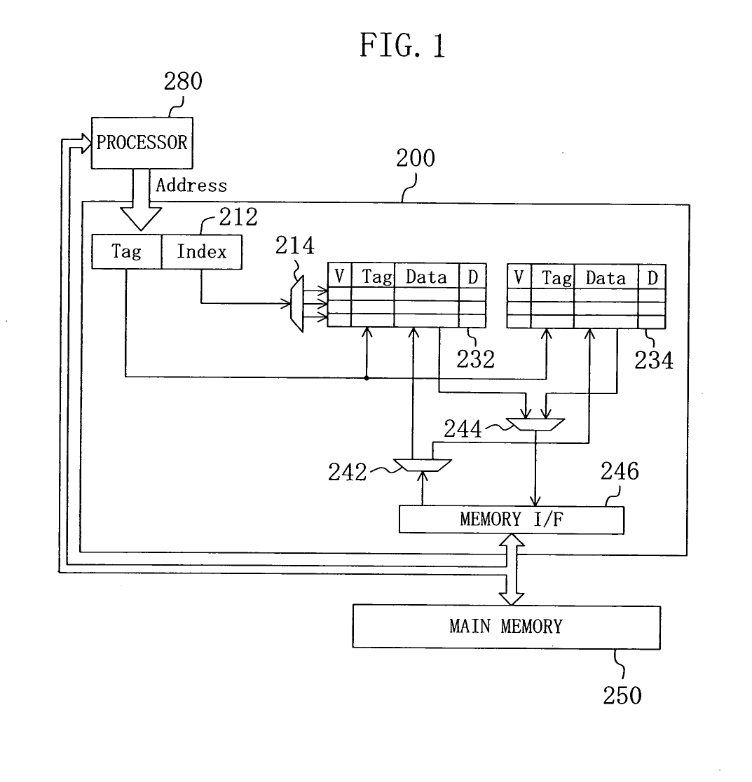

FIG. 1 is a block diagram illustrating an exemplary configuration of a cache memory device. The cache memory device 200 is used by a processor 280 for executing a program output by a program conversion apparatus according to an embodiment of the present invention. The cache memory device 200 of FIG. 1 includes an address register 212, a decoder 214, cache ways 232 and 234, selectors 242 and 244, and a memory interface (memory I/F) 246.

The address register 212 holds an input address so that a tag and an index are separated. The tag is stored in the cache way 232 or 234 and is used for judging whether or not data is present in a cache memory. The index indicates which part of the cache way 232 or 234 data is to be stored.

Each of the cache ways 232 and 234 includes a plurality of lines (cache lines) and holds data input from a main memory 250 and the processor 280 and the like. Each of the lines stores a V flag, a tag, data, and a D flag. The V flag indicates whether or not stored data is effective. The tag indicates an address of data stored in the cache memory. Data is a unit of data transfer with respect to the cache memory. The D flag indicates whether or not writing to the cache memory has been performed and contents of the cache memory are different from those in the same address in the main memory.

The memory I/F 246 performs data input/output with the main memory 250 and the processor 280 and also data input/output with the cache ways 232 and 234 via the selectors 242 and 244, respectively.

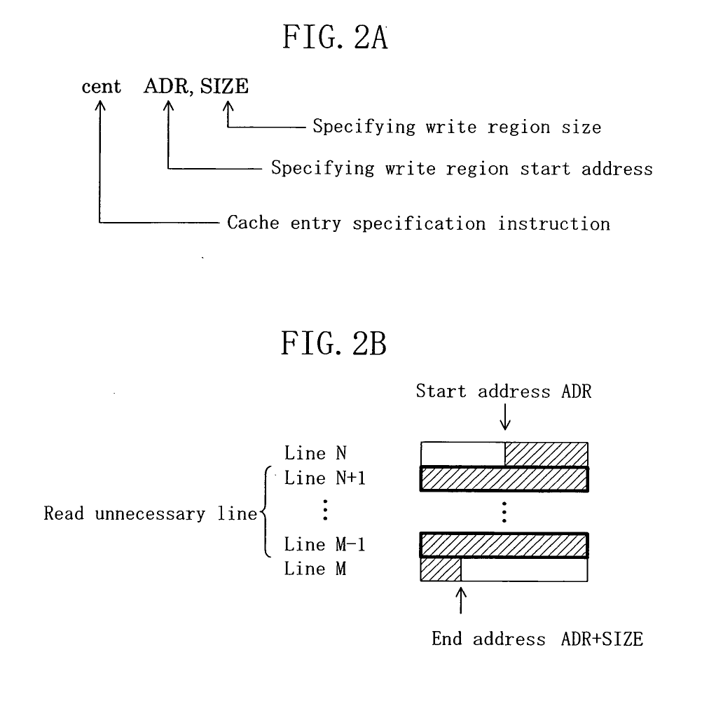

FIG. 2A is an explanatory drawing illustrating an exemplary cache entry specification instruction. This instruction is one of instructions that the processor 280 of FIG. 1 is capable of executing. The cache entry specification instruction (cent instruction) is an instruction to specify an entry in the cache memory. The cache entry specification instruction specifies a start address ADR and a size SIZE of a region (target region) in which a write access is to be performed, so that only the entry is added to the cache way 232 or 234.

FIG. 2B is an explanatory drawing illustrating setting of a reading unnecessary line in response to a cache entry specification instruction. A region (a start address ADR and an end address ADR+SIZE) specified by the cache entry specification instruction starts with a line N and ends with M (where M>N and each of M and N is a natural number). In this case, lines N+1 through M−1 each of which is entirely included in the region are reading unnecessary lines. For the reading unnecessary lines, a V flag and a tag are set in the cache way 232 or 234 (i.e., an entry is added), so that data reading to the cache memory is not performed thereto.

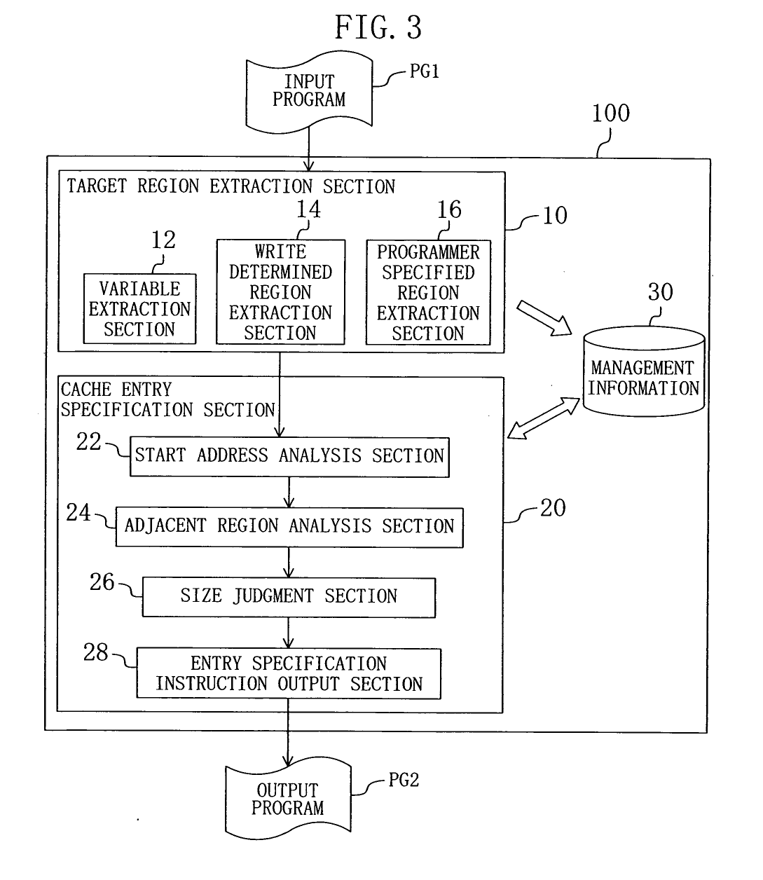

FIG. 3 is a block diagram illustrating an exemplary configuration of a program conversion apparatus according to an embodiment of the present invention. The program conversion apparatus 100 of FIG. 3 includes a target region extraction section 10 and a cache entry specification section 20. The program conversion apparatus 100 converts an input program PG1 into an output program PG2 and outputs the output program PG2. The target region extraction section 10 includes a variable extraction section 12, a write determined region extraction section 14, and a programmer specified region extraction section 16. The cache entry specification section 20 includes a start address analysis section 22, an adjacent region analysis section 24, a size judgment section 26, and an entry specification instruction output section 28.

The target region extraction section 10 analyzes the input program PG1 and extracts from regions of the main memory 250, a target region, i.e., a region to which writing is performed before initial reading from the region when the input program PG1 is executed, and registers the target region as management information 30. The management information 30 is stored in the main memory 250.

The start address analysis section 22 analyzes a start address of the target region. The adjacent region analysis section 24 analyzes memory access to adjacent regions located before and after the target region. The size judgment section 26 analyzes the size of the target region and controls output of the cache entry specification instruction. The entry specification instruction output section 28 generates a cache entry specification instruction for the target region registered as the management information 30, inserts the cache entry specification instruction before a memory write instruction to perform writing to the target region in the input program PG1, and then outputs the obtained output program PG2.

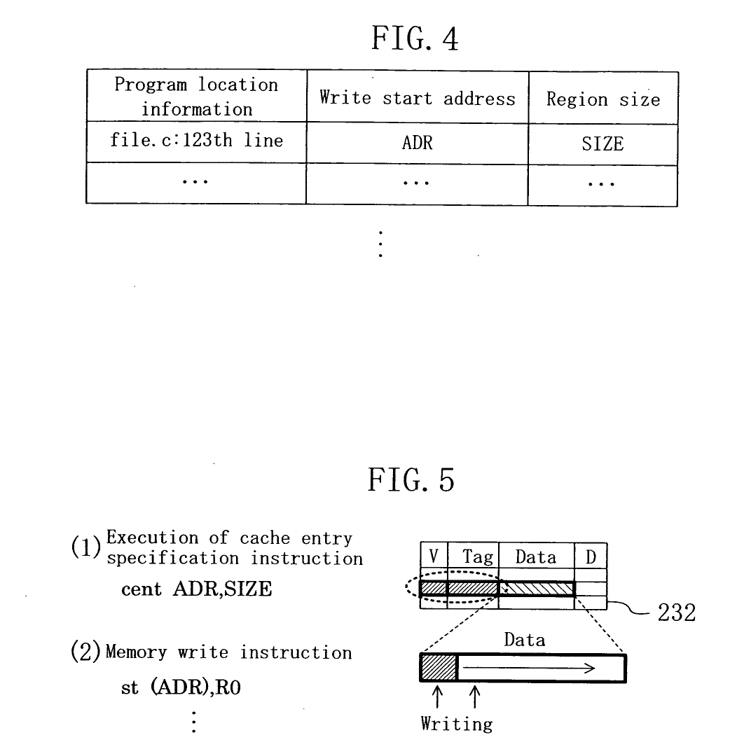

FIG. 4 is a table illustrating an example of the management information 30 of FIG. 3. Program location information, a write start address, and a region size are stored as the management information 30 for each target region. The program location information indicates a location in a program in which an instruction to perform a write access to a target region or the like is located. The write start address indicates a start address of a target region to which a write access is performed. The region size indicates the size of a target region.

FIG. 5 is an explanatory drawing describing the operation of an output program generated by the program conversion apparatus 100 of FIG. 3. First, the processor 280 for executing the output program PG2 executes a cache entry specification instruction cent to the target region extracted in the target region extraction section 10 and adds only an entry to the cache memory. Specifically, for the reading unnecessary lines of FIG. 2B, only the V flag and the tag in the cache ways 232 or 234 are updated.

Next, the processor 280 executes a memory write instruction st, so that write into the target region is performed. At this time, for each of the reading unnecessary lines, the entry has been already added to the cache way 232 or 234. Thus, it is possible to avoid unnecessary data reading from the main memory 250 to the cache way 232 or 234.

Hereinafter, the target region extraction section 10 of the program conversion apparatus 100 of FIG. 3 will be specifically described. The operation of each of the variable extraction section 12, a write determined region extraction section 14, and the programmer specified region extraction section 16 is independent. The target region extraction section 10 only has to include at least one of the variable extraction section 12, a write determined region extraction section 14, and the programmer specified region extraction section 16.

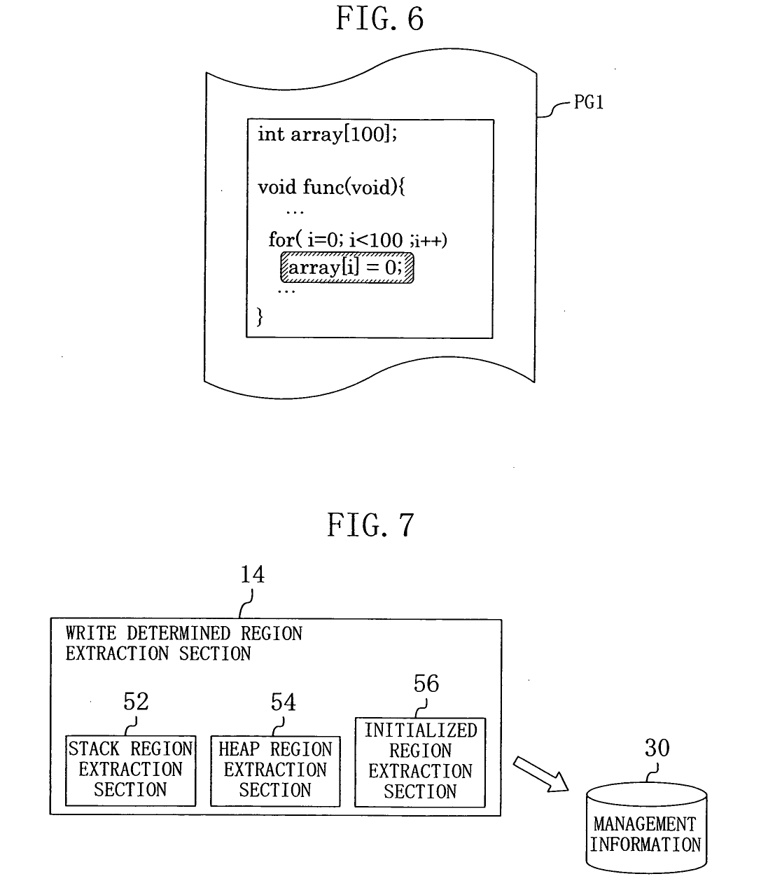

FIG. 6 is an explanatory drawing describing the operation of the variable extraction section 12 of FIG. 3. First, in the input program PG1, the variable extraction section 12 extracts a variable for which consecutive regions are allocated and writing is started before initial reading is performed (for example, array[i] of FIG. 6). Next, the variable extraction section 12 assumes a region in the memory corresponding to the extracted variable to be a target region and registers the region as the management information 30. If the variable is an array variable and appears in a loop, the variable extraction section 12 analyzes the range of a value for an array index, assumes all array elements to which writing is performed to be a target region, and registers the target region as management information 30.

FIG. 7 is a block diagram illustrating an exemplary configuration of the write determined region extraction section 14 of FIG. 3. The write determined region extraction section 14 includes a stack region extraction section 52, a heap region extraction section 54, and an initialized region extraction section 56. The operation of each of the stack region extraction section 52, the heap region extraction section 54, and the initialized region extraction section 56 is independent. The write determined region extraction section 14 only has to include at least one of the stack region extraction section 52, the heap region extraction section 54, and the initialized region extraction section 56.

The write determined region extraction section 14 extracts a region to which it has been determined to perform writing before an initial reading as a target region according to the nature of program language of the input program PG1. Examples of the write determined region are as follows.

For example, as for the stack region for realizing a function call, a value is indefinite right after the region has been allocated. Therefore, it is ensured that a write access is unfailingly performed first before a read access. That is, an initial access after the stack region has been allocated is always a write access. Also, as for the heap region for realizing a mechanism for dynamically allocating a memory while a program is executed, a value after the region has been allocated is indefinite and it is ensured that a write access is always performed first. Moreover, it is determined that a region for an external variable, a static variable or the like is initialized before a program is executed and, therefore, it is ensured that a write access is unfailingly performed first before a read access.

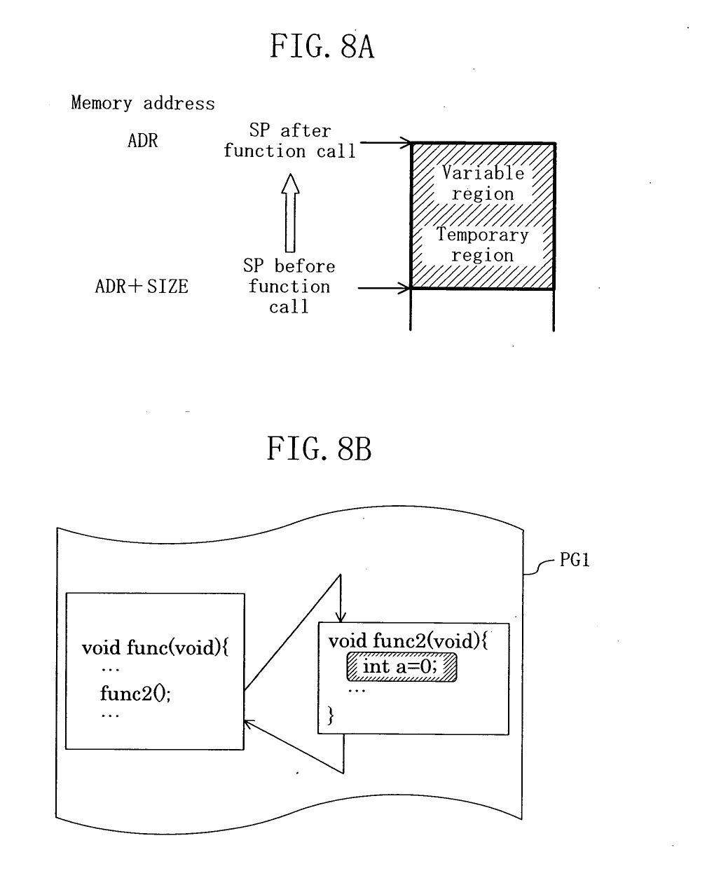

FIG. 8A is an explanatory drawing illustrating an example of allocation of a stack region when a function is called. When a function call is executed, a value for a stack pointer (SP) is changed according to a stack region used in the called function.

FIG. 8B is an explanatory drawing illustrating the operation of the stack region extraction section 52 of FIG. 7. The stack region extraction section 52 first analyzes the size of a stack region to be allocated while a function is called in the input program PG1, extracts the stack region as a target region, and then detects description for an initial writing to the stack region in the called function (for example, int a=0 in FIG. 8B). The stack region extraction section 52 registers an obtained result as the management information 30.

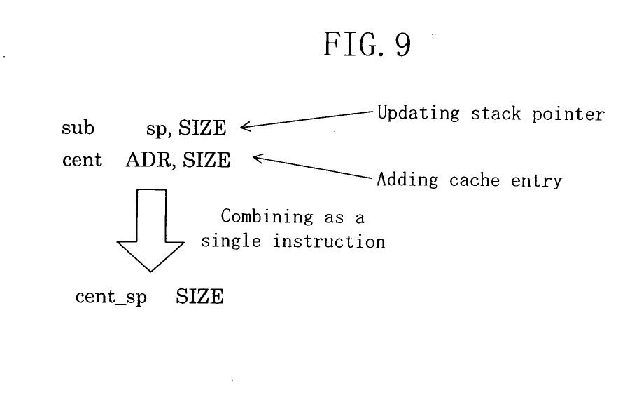

FIG. 9 is an explanatory drawing illustrating an exemplary instruction to support an operation when the stack region is allocated. When a cache entry is specified after the stack region has been allocated, the stack pointer is first updated by the size of the stack region by a subtraction instruction sub. Next, an entry(ies) corresponding to the stack region is added by the cache entry specification instruction cent.

In this case, an address and a size specified by the cache entry specification instruction cent are the same as a value of the stack pointer and the size specified by the instruction sub to update the address of the stack pointer, respectively. Therefore, it is effective in improving performance and eliminating the size of a program to combine the two instructions as one. Thus, the stack region extraction section 52 outputs, instead of the cache entry specification instruction cent and the instruction sub to update the address of the stack pointer, an instruction cent_sp, i.e., a combination of the cache entry specification instruction cent and the instruction sub.

The processor 280 for executing the output program PG2 includes a processing section so configured that an operation by the cache entry specification instruction to add only an entry to the cache memory and an operation by the instruction to update the address of the stack pointer can be executed by a single instruction cent_sp.

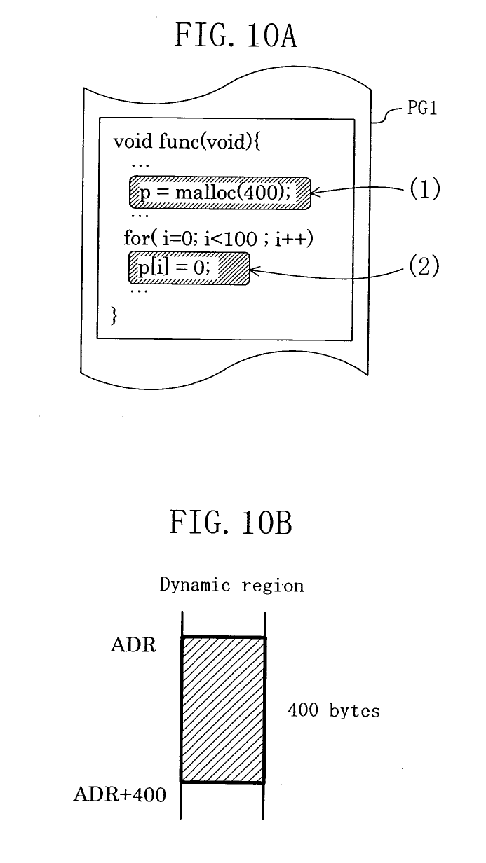

FIG. 10A is an explanatory drawing describing the operation of the heap region extraction section 54 of FIG. 7. FIG. 10B is an explanatory drawing illustrating an exemplary memory region to be dynamically allocated. In FIG. 10B, ADR denotes an address of a region to be allocated and the case where the size of the region is 400 bytes is shown.

First, the heap region extraction section 54 detects, in the input program PG1, part in which a memory region is dynamically allocated when a program is executed ((1) of FIG. 10A), obtains an address and a size of a heap region to be allocated, and extracts the heap region as a target region. Next, the heap region extraction section 54 detects, in the input program PG1, a location of description for an instruction and the like to perform an initial writing to the detected region ((2) in FIG. 10A). The heap region extraction section 54 registers an obtained result as the management information 30.

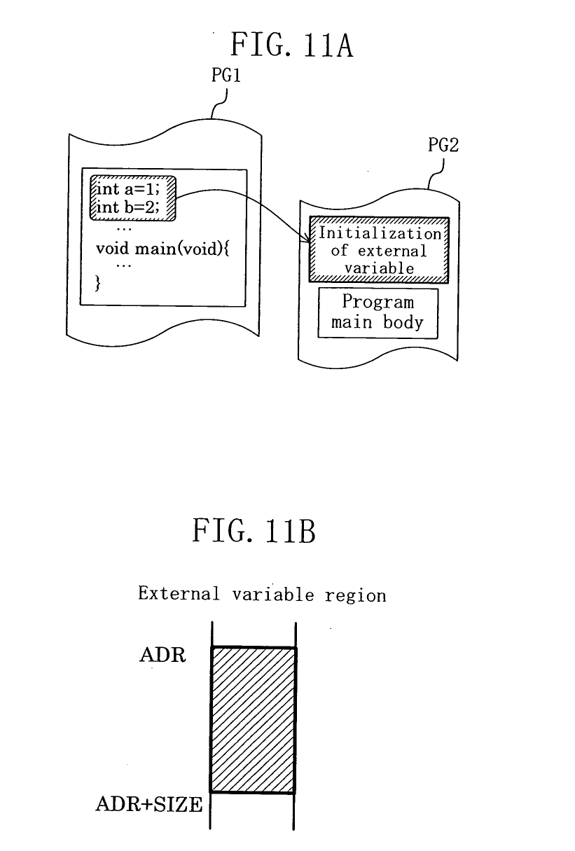

FIG. 11A is an explanatory drawing describing the operation of the initialized region extraction section 56 of FIG. 7. FIG. 11B is an explanatory drawing illustrating a memory region to be allocated as an external variable region. The external variable region is a region to be allocated for an external variable defined in the input program PG1. The external variable is a variable which it is determined to initialize when execution of the input program PG1 is started (before execution of a program main body is started). In FIG. 11B, ADR denotes an address of a region to be determined and the case where the size of the region is SIZE bytes is shown.

The initialized region extraction section 56 obtains an address, a size and the like of the external variable region from description for initialization for the external variable region and extracts the external variable region as a target region. As shown in FIG. 11A, the program conversion apparatus 100 outputs the description for initialization for the external variable region as part of the output program PG2 before the program main body is output. The initialized region extraction section 56 registers an obtained result as the management information 30.

Note that only the external variable in the input program PG1 has been described herein. However, a static variable which appears in a function and of which the address is fixed can be dealt with in the same manner.

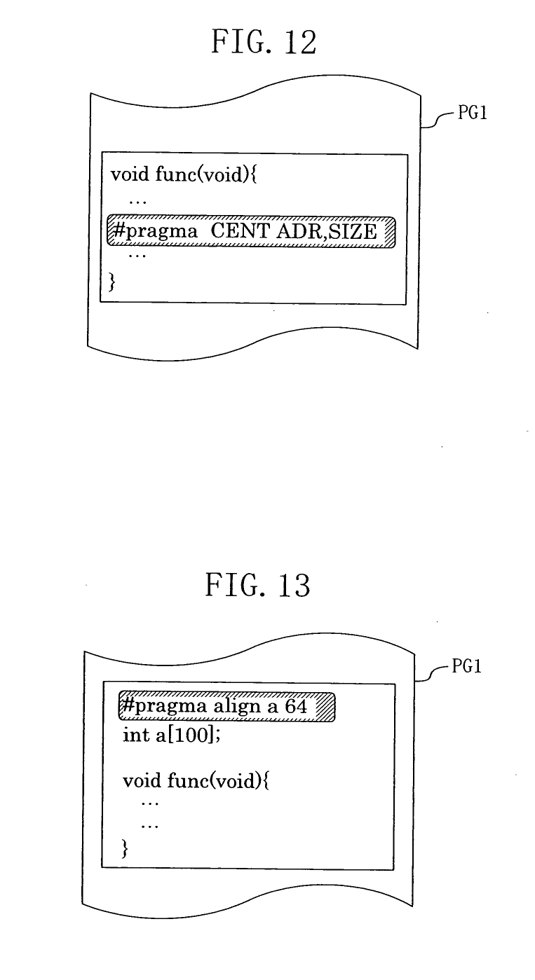

FIG. 12 is an explanatory drawing describing the operation of the programmer specified region extraction section 16 of FIG. 3. The programmer specified region extraction section 16 extracts, from the input program PG1, an instruction which a programmer gives to the program conversion apparatus 100. Specifically, the programmer specified region extraction section 16 extracts, as a target region, a region (with the address ADR and the size SIZE) specified by the programmer in the input program PG1, for example, as shown in FIG. 12. The programmer specified region extraction section 16 registers an obtained result as the management information 30.

To give an instruction to a program conversion apparatus, besides making description in a program as shown in FIG. 12, an instruction to specify a region to be extracted can be given as a parameter when the program conversion apparatus is started up. In this case, the programmer specified region extraction section extracts a region specified by the parameter as a target region.

Next, the cache entry specification section 20 of the program conversion apparatus 100 of FIG. 3 will be specifically described. Of elements constituting the cache entry specification section 20 of FIG. 3, the entry specification instruction output section 28 is a necessary element. On the other hand, the start address analysis section 22, the adjacent region analysis section 24, and the size judgment section 26 are elements for changing parameters for an cache entry specification instruction output from the entry specification instruction output section 28 and judging whether or not the instruction is to be output, and do not have to be provided in the cache entry specification section 20.

FIG. 13 is an explanatory drawing describing the operation of the start address analysis section 22 of FIG. 3. In the input program PG1 of FIG. 13, an alignment of a variable a is specified by a programmer.

In converting a program, an address of a variable might not be determined. Then, if a start address is not determined, the start address analysis section 22 analyzes an alignment of a start address of a target region extracted by the target region extraction section 10 and registered as the management information 30 and registers the obtained alignment as the management information 30. The start address and the alignment can be analyzed based on information for types of variables, information specified by a programmer and the like. Thus, by analyzing, if the start address is not determined, the alignment of the start address, where in a cache line(s) a target region is stored can be estimated.

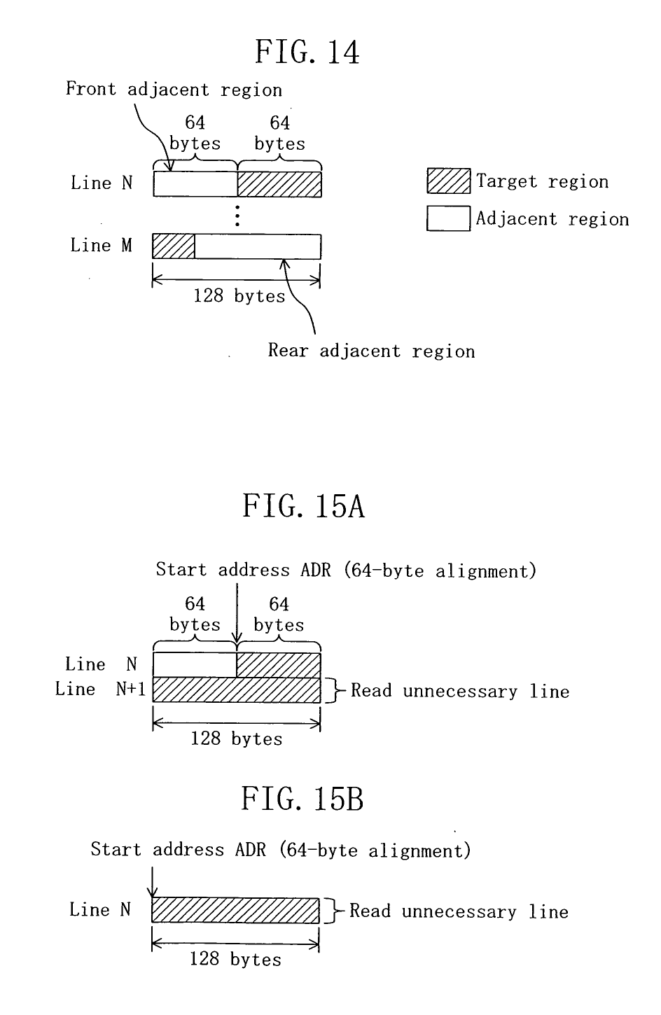

FIG. 14 is an explanatory drawing describing the operation of the adjacent region analysis section 24 of FIG. 3. An adjacent region is a region located before or after a target region of which information is stored as the management information 30 so as to be adjacent to the target region. When the target region is stored in the cache memory, the adjacent region is stored in the same cache line as the target region is stored. As the adjacent region, there are a front adjacent region (line N of FIG. 14) which is located before a target region so as to be adjacent to the target region and a rear adjacent region (line M) which is located after a target region so as to be adjacent to the target region.

The adjacent region analysis section 24 analyzes the management information 30 to extract an adjacent region and analyzes, after a cache line has been read, whether or not data in the adjacent region is referred to in the input program PG1. Moreover, if the data in the adjacent region is not referred to, the adjacent region analysis section 24 adds the adjacent region to the target region and registers the obtained region as the management information 30.

Assume that the target region is stored only in part of a cache line. If an entry of a cache for the line is added, correct data is not stored in the cache memory. Accordingly, when data in the adjacent region is referred to, an execution result of a program becomes an error. In contrast, if data in the adjacent region is not referred to, an execution result of a program does not become an error. That is, if there is no reference to the adjacent region, only an entry can be added to the cache memory and unnecessary reading from a main memory to the cache memory can be eliminated.

FIG. 15A is an explanatory drawing illustrating an exemplary target region having a necessary size for making the target region unfailingly include a read unnecessary line. FIG. 15B is an explanatory drawing illustrating an exemplary target region including a read unnecessary line and having a minimum size.

The size judgment section 26 analyzes, based on the size of a target region registered as the management information 30 and information for a start address, how many cache lines the target region actually includes. If the target region does not include a read unnecessary line (i.e., a cache line entirely included in the target region) at all, the size judgment section 26 controls the entry specification instruction output section 28 so that the entry specification instruction output section 28 does not output a cache entry specification instruction.

Assume that the start address ADR of the target region has a 64-byte alignment, a cache line has 128-byte alignment and the cache line has a size of 128 bytes. In the case of FIG. 15A, if the size of the target region is 192 bytes or more, the target region unfailingly includes a read unnecessary line. Moreover, in the case of FIG. 15B, if the size of the target region is 128 bytes or more, the target region can possibly include a read unnecessary line.

Then, with a start address of the target region not determined, only when the target region unfailingly includes a read unnecessary line, i.e., when the target region has, for example, a size of 192 bytes or more, the size judgment section 26 controls the entry specification instruction output section 28 so that the entry specification instruction output section 28 outputs a cache entry specification instruction. Also, with the start address of the target region not determined, when there is the possibility that the target region includes a read unnecessary line, i.e., when the target region has a size of, for example, 128 bytes or more, the size judgment specification section 26 may control the entry specification instruction output section 28 so that the entry specification instruction output section 28 unfailingly outputs a cache entry specification instruction.

If there is the possibility that the target region includes a read unnecessary line and the entry specification instruction output section 28 unfailingly outputs a cache entry specification instruction, depending on a value for the start address, there might be cases where the target region is not included and, even if the cache entry specification instruction is executed, the entry is not actually registered in the cache memory. Therefore, the program conversion apparatus 100 analyzes the cache entry specification instruction after an address has been determined. If it is found that the cache entry specification instruction does not include a read unnecessary line, the cache entry specification instruction is removed. Thus, a cache entry specification instruction which has no effect even when executed can be removed.

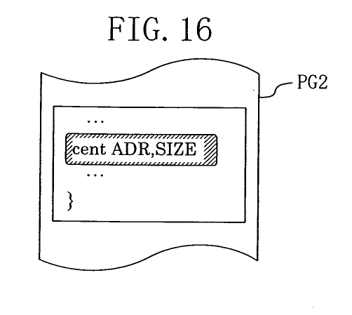

FIG. 16 is an explanatory drawing describing the operation of the entry specification instruction output section 28 of FIG. 3. The entry specification instruction output section 28 adds the cache entry specification instruction cent to the input program PG1 and outputs the resultant output program PG2 so that reading is not performed for the target region registered as the management information 30.

As described above, the program conversion apparatus 100 adds a cache entry specification instruction to an input program and then outputs the obtained program. Thus, for a target region in which a write access is performed before a read access, unnecessary reading from a main memory to the cache memory can be eliminated.

As has been described, the present invention allows elimination of unnecessary reading from a main memory to a cache memory when a program is executed, and is useful as a program conversion apparatus.

1. A program conversion apparatus for converting an input program into a program operable by a processor using a cache memory and outputting the converted program, the apparatus comprising:
a target region extraction section for extracting from regions of a memory, as a target region, a region in which writing is performed before reading during execution of the input program; and
a cache entry specification section for inserting a cache entry specification instruction to add an entry to the cache memory before an instruction to execute a write access to the target region.

2. The apparatus of claim 1, wherein the target region extraction section includes a variable extraction section for extracting a variable for which a continuous region is allocated and to which writing is started before reading from the variable, and assuming a region corresponding to the variable to be the target region.

3. The apparatus of claim 1, wherein the target region extraction section includes a write determined region extraction section for extracting, as the target region, a region in which it is determined that writing is performed before reading according to the nature of program language of the input program.

4. The apparatus of claim 3, wherein the write determined region extraction section includes a stack region extraction section for extracting, as the target region, a stack region to be allocated when a function is called.

5. The apparatus of claim 3, wherein the write determined region extraction section includes a heap region extraction section for extracting, as the target region, a heap region to be dynamically allocated during execution of the input program.

6. The apparatus of claim 3, wherein the write determined region extraction section includes an initialized region extraction section for extracting, as the target region, a region of a variable determined to be initialized when execution of the input program is started.

7. The apparatus of claim 1, wherein the target region extraction section includes a programmer specified region extraction section for extracting a specified region as the target region.

8. The apparatus of claim 1, wherein the cache entry specification section includes a start address analysis section for analyzing an alignment of a start address of the target region.

9. The apparatus of claim 1, wherein the cache entry specification section includes an adjacent region analysis section for analyzing whether or not an adjacent region to be stored in the same cache line as the target region is referred to in the input program and adding, if the adjacent region is not referred to, the adjacent region to the target region.

10. The apparatus of claim 1, wherein the cache entry specification section includes a size judgment section for controlling, if no cache line to be entirely included in the target region is present, the cache entry specification section so that the cache entry specification section does not output the cache entry specification instruction.

11. The apparatus of claim 10, wherein the size judgment section performs, if a start address of the target region is not determined, control so that the cache entry specification instruction is output when the target region has a size with which the target region unfailingly includes a whole single cache line.

12. The apparatus of claim 10, wherein the size judgment section performs, if a start address of the target region is not determined, control so that the cache entry specification instruction is output when the target region has a size with which there is the possibility that the target region includes a whole single cache line.

13. A processor comprising: a processing section for executing, by a single instruction, an operation by an instruction to update an address of a pointer indicating a stack region and an operation by an instruction to add an entry to a cache memory.
